(19) United States
(12) Patent Application Publication
(10) Pub. No.: US 2013/0082204 A1
(43) Pub. Date: Apr. 4, 2013

(54) Manual Control Part of a Suction Device

(71) Applicants: Daniel Bachi, Haag (CH); Elmar Morscher, Domat/Ems (CH)

(72) Inventors: Daniel Bachi, Haag (CH); Elmar Morscher, Domat/Ems (CH)

(73) Assignee: INTEGRA BIOSCIENCES AG, Zizers (CH)

(21) Appl. No.: 13/699,877

(22) PCT Filed: May 26, 2011
(86) PCT No.: PCT/CH2011/000123

§ 371 Date: Nov. 26, 2012

(30) Foreign Application Priority Data
May 26, 2010 (CH) 817/10

(51) Int. Cl. F16K 27/00

(52) U.S. Cl. CPC F16K 27/00
USPC 251/356

(57) ABSTRACT

The invention relates to a manual control part of a suction device with a valve, which manual control part can be adjoined downstream by a suction line and upstream by a pipette or pipette tip. The manual control part consists of a cylindrical, elastically deformable jacket, which defines a receiving space for a valve body, and of a valve body, which is received in the jacket and which defines, within the receiving space, a first space located in the upstream direction and a second space located in the downstream direction. In the valve body a flow connection between the first space and the second space is provided by at least one radially outwardly directed valve seat with a valve opening. The valve seat bears on the inner wall of the jacket, wherein the jacket can be compressed laterally of the valve seat in order to open the valve. In this way, the inner wall is moved away from the at least one valve seat.

### FIELD OF THE INVENTION

The invention relates to a manual control part of a suction device according to the pre-characterising clause of claim 1.

### PRIOR ART

Suction devices, which are also called aspirators, are used in particular in laboratories and in medical engineering to remove fluid residues, by way of example from open containers, by suction, A suction line is usually connected to a vacuum pump by a first end. A valve is operatively connected to the suction line for activation and deactivation of the suction function. The valve is usually incorporated in a manual control part to enable easy operation of the valve by the user. One possibility of a valve function consists in a clamping roller disconnecting and releasing the suction line. The clamping roller is pretensioned against the suction line and can be pushed away from the suction line by a control button, thus releasing the suction line. Further valve functions are implemented in that a piston or needle valve are integrated in the suction line and can be controlled by buttons arranged on the manual control part. The described manual control parts are distinguished by simple and exact adjustment of the suction performance using just one hand. The manual control parts are relatively complex in terms of construction, however, and are therefore difficult to clean and accordingly expensive to produce.

U.S. Pat. No. 4,913,401 discloses a valve arrangement having a valve inlet part and a valve outlet part. The two valve parts cooperate with an O ring seal. The valve parts and the seal are incorporated in an elastic hose. The seal cannot be axially moved since it is delimited by conical surface parts of the two sealing parts. If the hose is compressed by way of finger pressure, a passage forms between the seal and an extension part of the valve outlet part on which the seal is arranged. A fluid then flows through the valve arrangement by way of undercuts, which are provided in the valve inlet part, the gap, passage, gap and grooves which are provided on the surface of the valve outlet part, in the given sequence. The valve arrangement has only four individual parts and is therefore easy to dismantle. Metering by means of the valve arrangement is inaccurate, however, since the entire circumference of the two conical surface parts is used as a valve seat for the O ring, so no precisely defined passage is defined when the hose is compressed.

The valve which is proposed in U.S. Pat. No. 2,706,101 is similarly constructed to the valve arrangement described above. The valve has a rubber jacket in which first and second chambers are defined. A sealing flange is provided on the rubber jacket at the transition of the two chambers. The sealing flange cooperates with a tube which axially penetrates the rubber jacket and comprises an inlet part, a central part and an outlet part. If the rubber jacket is compressed in the region of the sealing flange by means of finger pressure, a through-opening between central part and sealing flange becomes free and this leads to the valve being fluidically passable. It is also essential in this respect that the tube has an outlet opening and an inlet opening and that the tube flow is interrupted by barrier a between these openings. This valve can also be easily dismantled. Dead spaces are produced in the tube owing to the barrier and these make easy cleaning difficult. The entire circumference of the tube also acts as a valve seat for the sealing flange. A defined cross-section cannot be formed by the through-opening, which forms when the sealing flange is deformed. Metering by means of this valve is therefore inaccurate.

WO 89/00262 describes a deformable valve having a valve body which defines a first valve chamber and a second valve chamber. The chambers are separated from each other by a flexible wall. A central opening with a circular sealing lip is provided in the wall. The sealing lip cooperates with a conical valve element. By pressing the circular ring, which is arranged in the region of the wall on the outside of the valve body, an opening between sealing lip and valve element is cleared, so the valve is opened. The entire circumference of the conical sealing element is provided as a valve seat in the case of this deformable valve as well, so accurate metering is not possible.

U.S. Pat. No. 6,039,305 describes a bite valve for a hydration bladder having a deformable sleeve and an elongate valve body. The valve body is connected to the sleeve so as to be sealed by way of a disc-like sealing element and a sealing element arranged at the end face. The sealing element is penetrated by a plurality of branching channels. A space in the sleeve is defined between the two sealing elements. Fluid can enter into the space through the disc-like sealing element by way of the branching channels. An axially extending shaft, which connects the sealing elements to each other, is located in the space. If the sleeve is externally deformed by a force, by way of example by biting together, in the region of the shaft, it is partially pressed inwards into the space. A passage consequently forms between the sealing element and the sleeve, resulting in opening of the valve. When the bite valve is released the sleeve returns to its starting position, so the valve is blocked. Since the bite valve does not pursue the aim of metering accuracy, as is required in the laboratory sector, and instead has the purpose of opening and closing a drinking tube for a user, metering with the bite valve is even more inaccurate than the above-described prior art. The inaccuracy of metering is therefore due to the fact that the entire cylinder jacket of the end face sealing element acts as a valve seat. This type of valve function is sufficient for sealing a drinking tube, however.

### OBJECT OF THE INVENTION

The object of the present invention is to propose a manual control part with a valve integrated in the manual control part, which is very simply constructed and is therefore inexpensive and despite the simple construction has high metering accuracy. A further aim is to disclose, with the target of high metering accuracy, a manual control part with as few individual parts as possible, so the manual control part is not very susceptible to faults and is easy to clean.

### DESCRIPTION

The invention relates to a manual control part of a suction device with a valve, to which manual control part a suction line can be adjoined downstream and a pipette or pipette tip can be adjoined upstream. The manual control part has an elastically defoiniable jacket, which defines a receiving space for a valve body. The elastic jacket can be compressed, so the valve can be opened. A first space located upstream and a second space located downstream are defined by the valve body, which is introduced into the jacket. The two spaces are connected by a flow connection which may be opened and closed by the valve. The two spaces are sealed from the environment by first and second sealing bodies. Since the jacket is elastic a sufficient seal may be easily established in that the jacket is pretensioned in the region of the sealing bodies. The external contour of the jacket can also have a form other than that of a cylinder. Elliptical shaping or other shapings which bring about different rigidities along the longitudinal axis of the jacket would also be conceivable.

According to the invention the object is achieved in a device according to the pre-characterising clause of claim 1 in that the valve body has a substantially radially protruding extension comprising a valve opening. The valve opening may be opened and closed exactly therefore since the valve opening provides a defined throughflow opening. The manual control part according to the invention consequently has very high metering accuracy. It is understood that the extension is fluidically connected to the valve body to enable suction from the pipette tip. It is also relevant to the invention that in the normal state the valve opening rests on the inner wall of the jacket. The jacket acts therefore as a valve cover which may be lifted and lowered. To open the valve the jacket can be compressed at a spacing from the valve opening and to the side thereof, bringing about displacement of the inner wall from the valve opening. The fluidic connection can therefore be produced between the first and second spaces by compressing the jacket. The manual control part preferably has just two components, namely the valve body and the jacket. This has the advantage that the manual control part can be produced extremely inexpensively. Susceptibility to faults is largely avoided since there are no moving parts. The manual control part is also very easy to clean since the valve body can be pulled from the jacket and the two individual parts can be cleaned separately. Dead spaces within the valve body and the jacket are basically avoided, and this facilitates cleaning further. The materials of the jacket and the valve body are preferably chosen such that they are resistant to chemicals and can be autoclaved. It would of course also be conceivable for the valve body and/or jacket to consist of more than one part.

The extension expediently has the form of a tube section. This shaping enables simple production of the valve body. The valve body, in particular if it is a cast part or injection moulded part, may be easily demoulded due to the shaping of a tube section. The valve seat mays also be circular at the free end of the tube section. This shape of the valve seat leads to improved sealing with respect to the inner wall of the jacket.

In a particularly preferred embodiment the valve body has two diametrically arranged valve openings on two free ends of two extensions or tube sections, which are arranged on the valve body between the first and second sealing bodies. Good metering accuracy is ensured by the two valve openings in the case of a larger required suction volume.

The first and second sealing bodies are advantageously spaced apart by an at least partially fluidically passable connecting body, the external diameter of which is smaller than the internal diameter of the jacket. There is consequently sufficient space for the jacket to compress in the region of the connecting body. The valve is completely open if the inner wall of the receiving space touches the connecting body. Appropriate dimensioning of the internal diameter of the receiving space, external diameter of the connecting body and diameter of the valve opening means the valve characteristics may be easily fixed. It is important that by compressing the jacket it is sufficiently convexly bulged in the region of the at least one valve opening in order to clear the valve opening. The connecting body is expediently fluidically connected to the at least one tube section. The tube section preferably stands orthogonally on the connecting body, enabling a tight valve seat. The tube section has a diameter which still allows sufficient clearance on either side of the tube section, relative to the longitudinal axis thereof, so the jacket can be compressed.

In one exemplary embodiment the receiving space is substantially cylindrical, preferably circular cylindrical. The receiving space is therefore easy to seal by means of the valve body since there are no corners or edges. The jacket is also easy to remove from the production mould when a cylindrical receiving space is provided.

It has proven to be advantageous if the valve body has a first end and a second end which are implemented as first and second, preferably cylindrical, sealing bodies. The external diameters of the sealing bodies are equal to or advantageously slightly larger than the internal diameter of the receiving space at the respective contact areas. In the case of the manual control part according to the invention, a slight difference between the external diameter of the sealing body and the internal diameter of the receiving space is taken to mean a difference which is preferably between 0.1 mm and 2 mm. The elastically expandable jacket therefore rests on the first and second sealing bodies so as to be pretensioned. This leads to simple and effective sealing of the receiving space with respect to the environment and this is essential for perfect suction.

The valve body expediently has two diametrically arranged valve openings which are arranged on the valve body between the first and second sealing bodies. The spacing of the two valve openings from each other is preferably slightly greater than the internal diameter of the receiving space. In the case of the manual control part according to the invention a slightly greater difference between the spacing of the two valve openings and the internal diameter of the receiving space is taken to mean a difference which is preferably between 0.1 mm and 2 mm. The receiving space is therefore elastically widened in the region of the two valve openings, so the valve is sealed when the jacket is not compressed. The position of the valve openings relative to the jacket is chosen such that it does not impede compression of the jacket. The spacings of the two valve openings with respect to the longitudinal axis of the valve body can also be different from each other. The valve openings are therefore cleared one after the other, and not simultaneously, in this case when the jacket is compressed. This is important by way of example if the valve is to be opened in a decelerated manner.

In a preferred exemplary embodiment the first space is formed by the gap which the valve body leaves free in the receiving space when it is received. The second space is accordingly formed by a flow channel, which extends downstream in the valve body from the at least one valve opening to the first sealing body. In this exemplary embodiment a liquid to be removed by suction flows first of all into the receiving space and, after passing the valve, into the flow channel. Sealing of the valve opening is improved therefore since the jacket is sucked onto the valve seat once the valve has been closed.

In a particularly preferred exemplary embodiment the first space is formed by a flow channel which extends downstream in the valve body from the first sealing body to the at least one valve opening. The second space is consequently defined by the gap which results between the receiving space and the valve body when the valve body is received. In this exemplary embodiment a liquid to be removed by suction flows first of all into the flow channel and, after passing the valve, into the receiving space. The flow channel can also be sucked empty once the desired quantity of fluid has been removed by suction. Once the valve has been closed this leads to a drip-free pipette or pipette tip.

Advantageously provided on the valve body between the at least one valve opening and the second sealing body is at least one suction opening which is fluidically connected to a hose stem arranged on the outside of the second sealing body. For operation of the valve it is advantageous for it to be possible to remove the liquid from the receiving space again by suction. The suction opening is arranged as close as possible to the second sealing body to be able to keep the flow connection to the end face of the second sealing body as short as possible. By providing the suction opening a vacuum can also be produced in the receiving space once the valve has been closed, and this improves the tightness of the valve.

Two suction openings are expediently formed by a transverse channel which penetrates the valve body at an angle to its longitudinal axis, preferably at an angle of 90°. The two suction openings are accordingly implemented by a simple transverse hole in the connecting body.

A hose stem is advantageously arranged on the end face of the first or second sealing body for fixing the suction line. The suction line can therefore be quickly connected to the first or second sealing body, depending on the direction of flow, simply by pushing it on.

Valve body and jacket are preferably connected to each other by positive or frictional locking. A web is advantageously arranged in the receiving space on its inner wall. To positively hold the valve body in the receiving space the web cooperates with an encircling groove which is provided on the circumferential surface of the first sealing body. The valve body is held in the receiving space as a result. Due to the elastic behaviour of the jacket, however, the valve body can also be pulled out of the jacket, by way of example for cleaning purposes. For reasons relating to production engineering and tightness the web is preferably designed so as to be circumferentially closed.

In a further exemplary embodiment two diametrically arranged grips, by way of example for thumb and index finger, are formed on the circumferential surface of the jacket. The grips show the user the exact position for operating the valve. This is relevant since the jacket can only be compressed to the side of the at least one valve opening.

Expediently provided on the wide sealing body is an extension which can be received in a recess on the jacket as a positioning aid and anti-twist guard. The sealing body is always received in the correct position relative to the grips in the jacket thanks to this simple constructional measure.

No further extension is necessary on the valve body as a result of the fact that a suspension device is advantageously provided on the second sealing body, with the extension connecting the suspension device to the valve body. The suspension device is used to hold the manual control part on a stand or the like when it is not being used.

The first sealing body advantageously has a flattened portion in the shape of a truncated cone. The seal between the jacket and the first sealing body is improved by the truncated cone since it rests on a negative form of the truncated cone provided in the jacket. The truncated cone is also used to facilitate insertion of the valve body into the receiving space.

The length of the connecting body and the elasticity of the jacket are expediently dimensioned in such a way that the valve can be opened against atmospheric pressure and against the elastic force of the jacket by compressing the jacket. The manual control part can therefore be adapted during its production to the required suction power.

It has proven to be advantageous if a preferably tapering receiver is provided for pipettes or pipette tips at the end of the jacket which lies closer to the first sealing body, and this receiver is fluidically connected to the valve body. Pipettes or pipette tips with different diameters can therefore be received on the manual control part.

In a further embodiment one of the two valve openings is fluidically connected to the receiver and the other of the two valve openings is fluidically connected to the hose stem. If the excess part of the two valve openings with respect to the inner wall is preferably additionally different, a valve seal characteristic may be achieved with this embodiment in which firstly the valve opening which is connected to the receiver closes. Only then does the valve opening which is connected to the hose stem close. Closure of the valve assisted by external pressure with simultaneously minimized dripping of the pipette tip may be achieved as a result.

The jacket is expediently produced from an elastomer and the valve body from a duroplastic or thermoplastic, such as by way of example polypropylene. The choice of material means that the jacket and valve body have exactly those properties which are necessary for reliable valve operation. The selected plastic materials are preferably also resistant to chemicals, easy to clean and/or can be autoclaved.

Further advantages and features emerge from the following description of an exemplary embodiment of the invention with reference to the schematic diagrams, in which not to scale:

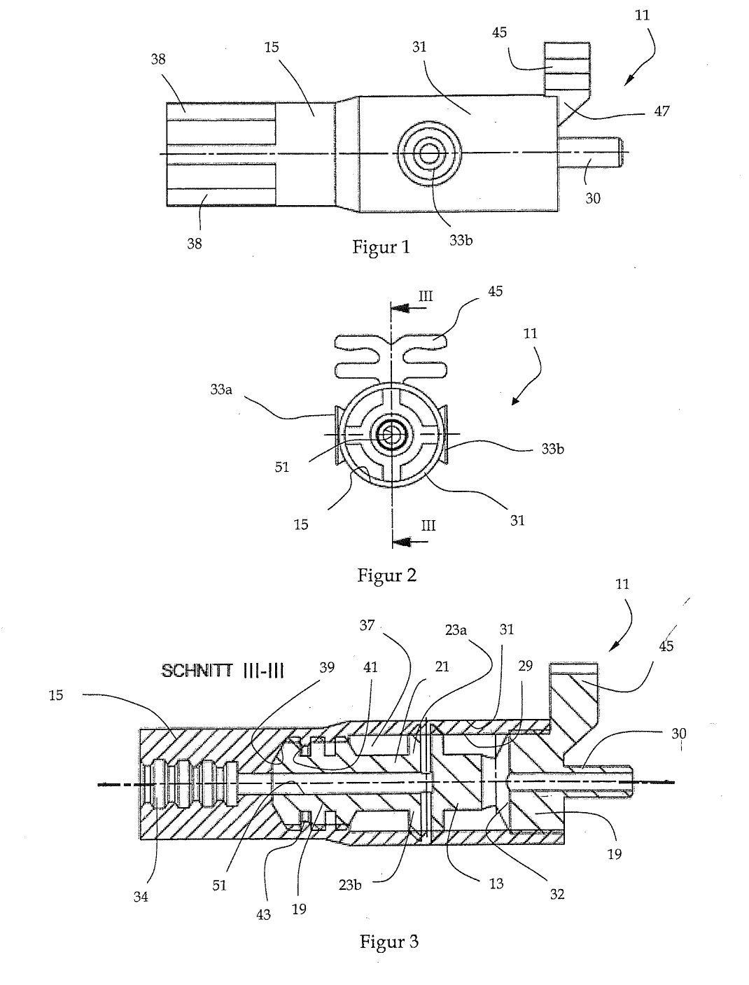

FIG. 1 shows a manual control part according to the invention in which a valve body is received in a jacket;

FIG. 2 shows a side view of the manual control part from FIG. 1;

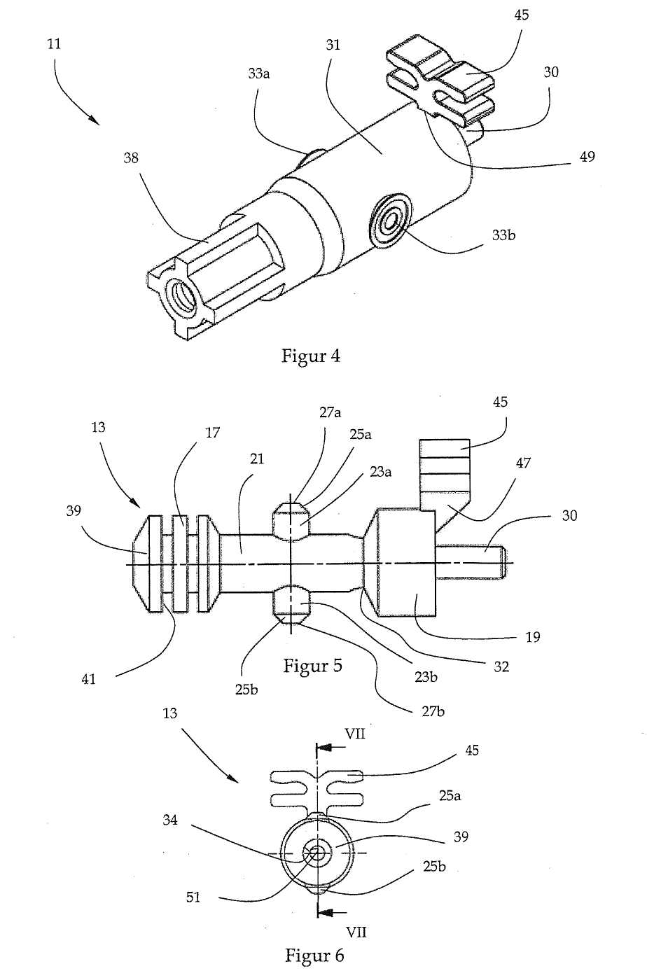

FIG. 3 shows a sectional view at the position A-A from FIG. 2;

FIG. 4 shows a perspective view of the manual control part;

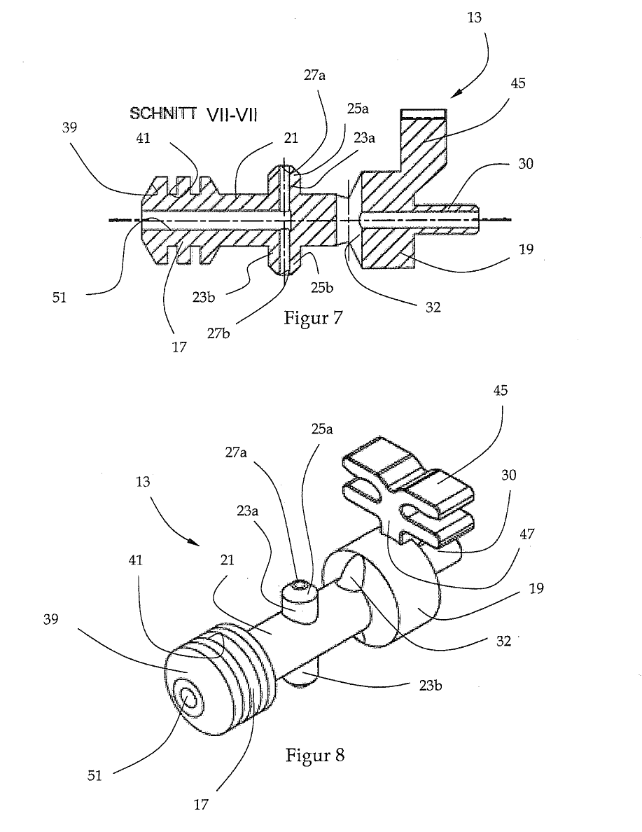

FIG. 5 shows a front view of the valve body;

FIG. 6 shows a side view of the valve body from FIG. 5;

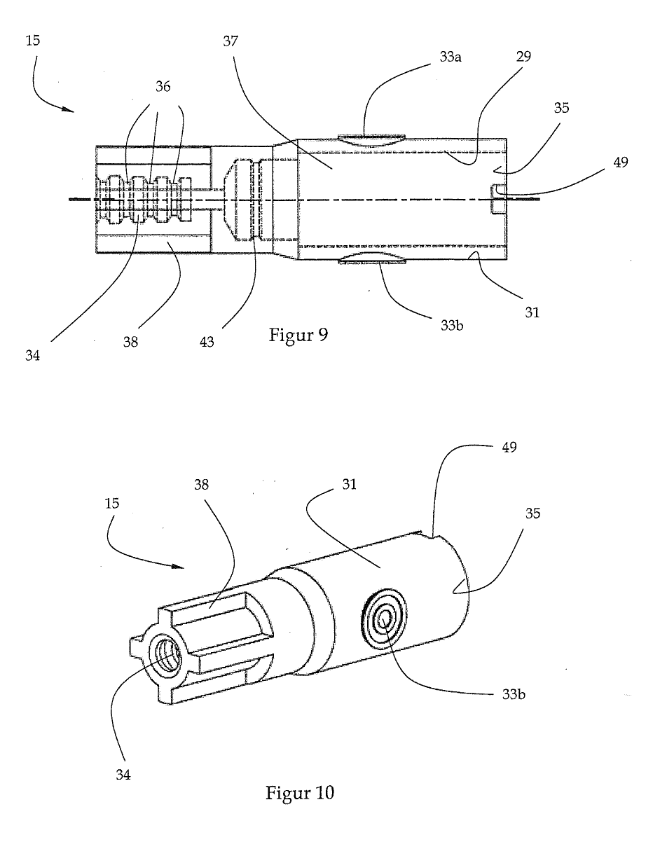

FIG. 7 shows a sectional view of valve body at the position A-A from FIG. 6;

FIG. 8 shows the valve body in a perspective view;

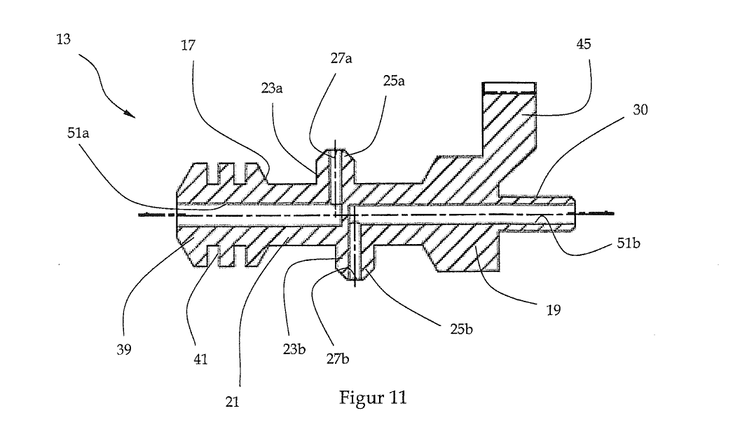

FIG. 9 shows a jacket for receiving the valve body in a front view;

FIG. 10 shows a perspective view of the jacket and

FIG. 11 shows a sectional view of an embodiment with a further possible flow system.

FIGS. 1 to 4 show a manual control part according to the invention of a suction device (not shown in detail) which is designated as a whole by reference numeral 11. The manual control part 11 has a very simple construction since it consists of just two parts, namely a valve body 13 and a jacket 15. FIG. 3 shows the valve body 13 in section in wide hatching and the jacket 15, in which the valve body 13 is received, in narrow hatching. The valve body 13 is produced from a slightly deformable plastic material, such as by way of example polypropylene, whereas the jacket 15 is produced from an elastic material such as rubber or silicone. A pipette tip can be pushed onto a first end face of the manual control part 11 and a suction line, which is connected to a vacuum pump, can be adjoined at a second end face. The pipette and suction line are not shown in the figures. The valve body 13 and jacket 15 cooperate in such a way that a flow passage through the manual control part 11 is opened by compressing the jacket 15. A liquid is then sucked into the pipette tip and leaves the manual control part 11 through the suction line. If the elastic jacket is in its starting or normal position, the flow passage through the manual control part 11 is closed and there is no suction effect at the pipette tip. The valve function, which is achieved by the cooperation of the valve body 13 and the jacket 15, is described in detail below.

FIGS. 5 to 8 show the valve body 13. The first and second ends of the valve body are constructed as a first sealing body 17 and a second sealing body 19. The first and second sealing bodies 17, 19 have a cylindrical form and are spaced apart from each other by a cylindrical connecting body 21. Two tube sections 23a, 23b, whose free ends are constructed as valve seats 25a, 25b with valve openings 27a, 27b, extend from the connecting body 21. The valve openings 27a, 27b rest on the inner wall 29 of the jacket 15 when the valve is closed. For this purpose the end faces of the tube sections are preferably curved or designed so as to be adapted to the radius of the jacket respectively. A hose stem 30 is provided on the free end face of the second sealing body 19 for connection of the suction line. The hose stem 30 is fluidically connected to a transverse channel 32. The transverse channel 32 is provided on the connecting body 21 between the second sealing body 19 and the tube sections 23a, 23b.

FIGS. 9 and 10 show the jacket 15. As already mentioned above, the jacket 15 is to be compressed in order to open the valve. Two grips 33a, 33b are diametrically arranged on the outer wall 31 of the jacket to indicate to the user the correct position at which the jacket is to be compressed. A tapering receiver 34 for pipettes or pipette tips is provided on the end face of the jacket 15 which faces the first sealing body 17. The taper means pipette tips with different diameters can be received. For secure retention of the different pipette tips the receiver 34 is fitted with shoulders 36. Stabilising webs 38 are arranged on the outer wall 31 in the region of the receiver 34 to improve the retention of the pipette tip in the receiver 34.

The valve body is pushed into a cylindrical receiving space 37 via a receiving opening 35. To produce a sealing fit between the first and second sealing bodies 17, 19 and the inner wall 29, the sealing bodies 17, 19 have an external diameter which is slightly larger than the internal diameter of the inner wall 29 at the corresponding points. To receive the sealing bodies 17, 19 the receiving space 37 is widened in the region at which the sealing bodies 17, 19 rest on the inner wall 29. The elastic properties of the jacket 15 mean that the inner wall 29 rests on the sealing bodies so as to be pretensioned. The sealing effect of the first sealing body 17 is improved still further by its free end in the form of a flattened portion in the shape of a truncated cone 39. The truncated cone 39 is also used for simplified insertion of the valve body 13 into the receiving space 37. It can be seen from FIG. 3 that the valve seats 25a, 25b diametrically arranged on the connecting body have a spacing from each other which is slightly greater than the internal diameter of the receiving space 37 at the corresponding point. The inner wall 29 therefore also rests on the valve seats 25a, 25b so as to be pretensioned.

To improve the fit of the valve body 13 in the receiving body 37 still further an encircling groove 41 is provided on the first sealing body 17. The grove 41 cooperates positively with a preferably circumferential web 43 which is formed on the inner wall 29 in the region of the first sealing body 17. A suspension device 45 is fixed by means of an extension 47 at the free end of the second sealing body 19 on the outer wall thereof. When it is not being used the manual control part 11 can be suspended by way of example on a stand or the vacuum pump. The extension 47 is also used as a positioning aid, so the grips 33a, 33b are oriented parallel to the tube sections 23a, 23b. For this purpose the extension 47 is received in a receiver 49 with positive fit, the receiver being provided at the transition from the outer wall 31 to the receiving opening 35. The extension 47 is also used as an anti-twist guard since the valve body 13 can no longer be rotated relative to the jacket 15 if the extension 47 is received in the receiver 49.

The fluid flow may best be seen in FIG. 3. If the grips 33a, 33b are compressed the inner wall 29 is displaced from the valve seats 25a, 25b in that the jacket is pressed along the tube sections 23a, 23b from its substantially circular cross-sectional form into an elliptical cross-sectional form. A liquid which is to be removed by suction is sucked from a pipette tip held in the jacket into the manual controller. The liquid enters a flow channel 51 at the free end face of the first sealing body 17. The liquid branches through the flow channel 51 into the two tube sections 23a, 23b and leaves them at the valve openings 27a, 27b. The liquid accordingly spreads into the regions of the receiving space 37 which are not filled by the valve body 13. The liquid leaves the manual control part 11 through the transverse channel 32, the second sealing body 19 and the hose stem. The flow of liquid can be metered in that the grips 33a, 33b are not compressed until they abut on the valve body 21. Once the suction process has finished the pipette tip can still be sucked empty before the valve is closed. The pipette tip does not drip afterwards therefore. When the grips 33a, 33b are released the valve is closed in that the inner wall 29 comes into contact with the valve seats 25a, 25[13]. The receiving space 37 is sucked empty through the transverse channel 32, resulting in a vacuum in the receiving space 37. It is very easy to clean the manual control part 11 after it has been used. The valve body 13 simply has to be pulled out of the jacket. The two parts can then be cleaned separately, by way of example by autoclaving.

It is also conceivable for the flow direction to be reversed, i.e. for the liquid to enter the manual control part 11 through the second sealing body 19. With this embodiment the receiving space 37 is not sucked completely empty after the valve has been closed but the inner wall 29 is sucked onto the valve seats 25a, 25b once the valve has been closed. This leads to improved tightness of the valve.

A flow system is also conceivable which is shown in FIG. 11. In this the valve seat 25a is fluidically connected to the receiver 34 via a flow channel 51a. The valve seat 25b is fluidically connected to the hose stem 30 via a flow channel 51b. FIG. 11 shows that the tube sections 23a and 23b are arranged mutually offset on the connecting piece 21 so the flow channels 51a and 51b do not intersect. In addition the tube section 23a is slightly longer than the tube section 23b. During the suction removal process the liquid enters the receiving space 37 through the valve opening 27a and leaves it through valve opening 27b. If the user releases the jacket 15 at the grips 33a, 33b, the valve seat 25a is sealed firstly by the inner wall 29. Only then is the inner wall 29 sucked onto valve seat 25b. Dripping of the pipette tip can be avoided by way of this separate sequential closing of the valve seats 25a, 25b. Sealing of the valve seats 25a, 25b is also assisted by external pressure, i.e. by atmospheric pressure.

### LEGENDS

11 manual control part

13 valve body

15 jacket

17 first sealing body

19 second sealing body

21 connecting body

23a, 23b tube sections

25a, 25b valve seats

27a, 27b valve openings

29 inner wall of jacket

30 hose stem

31 outer wall of jacket

32 transverse channel

33a, 33b grips

34 tapering receiver

35 receiving opening

36 shoulders

37 receiving space

38 stabilising webs

39 truncated cone

41 groove

43 web

45 suspension device

47 extension

49 receiver

51, 51a, 51b flow channel

1. A manual control part of a suction device with a valve, to which manual control part a suction line can be adjoined downstream and a pipette or pipette tip can be adjoined upstream, said manual control part comprising:
an elastically deformable jacket, which defines a receiving space for a valve body,
a valve body, which is received in the jacket and which defines, within the receiving space, a first space located in the upstream direction and a second space located in the downstream direction, and at its ends has a first sealing body and second sealing body, and
an interruptible flow connection between the first space and the second space, wherein
the valve body has a substantially radially protruding extension comprising a valve opening, which valve opening rests in a normally closed state on an inner wall of the jacket, and wherein the jacket is spaced apart from the valve body to the side of the extension, so the flow connection between the first space and the second space can be opened by compressing the jacket.

2. A manual control part according to claim 1, wherein the extension has the form of a tube section.

3. A manual control part according to claim 1, wherein the valve body has two diametrically arranged valve openings a two free ends of two extensions or tube sections, which are arranged on the valve body between the first and second sealing bodies.

4. A manual control part according to claim 1, wherein the first and second sealing bodies are spaced apart by at least one partially fluidically passable connecting body, the external diameter of which is smaller than the internal diameter of the jacket and which is fluidically connected to the extension or the tube section.

5. A manual control part according to claim 1, wherein the receiving space is substantially cylindrically formed.

6. A manual control part according to claim 1, wherein the external diameters of the sealing bodies are equal to or slightly larger than the internal diameter of the receiving space at the respective contact areas.

7. A manual control part according to claim 3, wherein the spacing of the valve openings from each other is greater than the internal diameter of the receiving space, wherein the spacings of the two valve openings from a longitudinal axis of the valve body are different from each other.

8. A manual control part according to claim 1, wherein the valve body between the valve opening and the second sealing body is has at least one suction opening which is fluidically connected to a hose stem arranged on the outside of the second sealing body.

9. A manual control part according to claim 8, wherein two suction openings are formed by a transverse channel which penetrates the valve body obliquely to its longitudinal axis.

10. A manual control part according to claim 1, wherein an end face of the first or second sealing bodies is a hose stem for securing the suction line.

11. A manual control part according to claim 1, wherein the receiving space, on it inner wall, has a web for positive retention of the valve body in the receiving space comprising an encircling groove which is provided on the circumferential surface of the first sealing body.

12. A manual control part according to claim 1, wherein two diametrically arranged grips are formed on the outer wall of the jacket.

13. A manual control part according to claim 1, wherein provided on the second sealing body is an extension which can be received in a recess on the jacket as a positioning aid and anti-twist guard.

14. A manual control part according to claim 13, wherein the second sealing body is a suspension device, wherein the extension connects the suspension device to the valve body.

15. A manual control part according to claim 14, wherein the first sealing body has a flattened portion in the shape of a truncated cone.

16. A manual control part according to claim 4, wherein the length of the connecting body and the elasticity of the jacket are dimensioned in such a way that the valve can be opened against external pressure by compressing the jacket.

17. A manual control part according to claim 4, wherein the jacket is produced from an elastomer and the valve body is produced from a duroplastic or thermoplastic.

18. A manual central-control part according to claim 1, wherein the first space is defined by a gap which the valve body leaves free in the receiving space when the valve body is received, and the second space if formed by a flow channel, which extends downstream in the valve body from the at least one valve opening to the first sealing body.

19. A manual control part according to claim 1, the first space is formed by a flow channel which extends downstream in the valve body from the first sealing body to the at least one valve opening, and the second space is defined by a gap which the valve body leaves free in the receiving space when the valve body is received.

20. A manual control part according to claim 19, wherein the end of the jacket, which faces the first sealing body, includes a conical receiver for pipettes or pipette tips, which are fluidically connected to the valve body.

21. A manual control part according to claim 19, wherein one of the two valve openings is fluidically connected to the receiver and the other of the two valve openings is fluidically connected to the hose stem.
